(19) United States
(12) Patent Application Publication
(10) Pub. No.: US 2006/0282349 A1
(43) Pub. Date: Dec. 14, 2006

(54) Product transport control system

(75) Inventor: Koji Yoshida, Suwa-shi (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION, Suwa-shi (JP)

(21) Appl. No.: 11/452,261

(22) Filed: Jun. 14, 2006

Related U.S. Application Data
(63) Continuation of application No. 10/078,263, filed on Feb. 20, 2002.

(30) Foreign Application Priority Data
Feb. 20, 2001 (JP) 2001-043734
Feb. 20, 2001 (JP) 2001-043735

(51) Int. Cl. G06Q 10/00

(52) U.S. Cl. 705/28

(57) ABSTRACT

By a computer for product transport control, data concerning products and data concerning shipment, which have been input from computers installed at production sites, and data concerning transport conditions, which have been input from computers installed at transporting agencies that transport the products, are received via a network, unified control is performed by preparing product transport control data for controlling the products and the transport of products, and the product transport control data are output according to requests. At a computer installed at a sales office, the product transport control data are input as necessary via a network and displayed to make known the transport conditions of the products shipped to the sales office.

This is a continuation of application Ser. No. 10/078,263 filed Feb. 20, 2002. The entire disclosure of the prior application, application Ser. No. 10/078,263 is considered part of the disclosure of the accompanying continuation application and is hereby incorporated by reference.

### BACKGROUND OF THE INVENTION

1. Field of the Invention

This invention concerns an apparatus and method for control of products and control of the transport of the products.

2. Description of the Prior Art

As a form of such a transport control apparatus, a apparatus by which a transporting agency controls its own transportation has been proposed. With this apparatus, when for example the transporting body is a vessel, the on board date, which is the date on which the object to be transported has been loaded onto the vessel, the bill of lading number, the navigation position of the vessel, expected date of arrival, etc. are input and these data are output as necessary.

However, with such a transport control apparatus, it is difficult in many cases for the receiving side (for example, the cargo owner), which receives the object being transported, to carry out control of the transported object. For example, when the transported object receiving side prepares a sales schedule of a product, which is the transported object, the timing of receipt of the product must be known at high certainty in order to prepare a more appropriate sales schedule, and an inquiry must be made to the transporting agency regarding the scheduled date of arrival of the transported object in order to calculate the timing of receipt. However, the scheduled date of arrival is in many cases changed due to the transporting environment (for example, the weather), and the changed scheduled date of arrival is not notified in many cases unless the receiving side makes an inquiry. An appropriate sales schedule therefore cannot be prepared under such circumstances. Appropriate control of sales, inventory, etc. of the product, which is the transported object, thus cannot be carried out and an appropriate sales schedule cannot be prepared.

### SUMMARY OF THE INVENTION

An object of this invention is to carry out control of products entrusted to transporting agencies. Another object of this invention is to enable output as necessary of the transport control conditions of products that are in the process of transport and thereby enable use of such information in the sales planning, inventory control, etc. of the products. Yet another object of this invention is to automate product registration processes, such as receiving registration, inventory registration, etc. Yet another object of this invention is to carry out allocation of products that are in the process of transport.

This invention employs the following means for achieving at least a part of the above mentioned objects.

The present invention is directed to a product transport control system. The product transport control system includes production site computers installed at multiple production sites, transporting agency computers installed at multiple transporting agencies, and a product transport control computer for controlling products produced at the production sites and controlling a transport of the products, which are connected via a network. Each of the production site computers includes; an information input part for inputting product information concerning the products produced at the production sites and shipment information concerning the shipment of the products, and an information transmitting part for transmitting the product information and the shipment information to the product transport control computer via the network. Each of the transporting agency computers includes; an information input part for inputting transport information concerning transport by means of transporting bodies, and an information transmitting part for transmitting the transport information to said product transport control computer via the network. The product transport control computer includes; a product shipment information receiving part for receiving the product information and the shipment information transmitted from said production site computers, a transport information receiving part for receiving the transport information transmitted from said transporting agency computers, an information storage part for integrating and organizing the product information and the shipment information received by the product shipment information receiving part and the transport information received by the transport information receiving part to store as product transport control information, a search request receiving part for receiving predetermined search requests via the network, a searching part that, when the search request receiving part received the predetermined search requests, searches the product transport control information stored in the information storage part based on the predetermined search requests, and an information output part for outputting at least part of the product transport control information searched by the searching part to a requester of the predetermined search requests.

In the product transport control system of the present invention, the information storage part integrates and organizes the product information and the shipment information input by the production site computers and the transport information input by the product transport control computer to store as the product transport control information. The information output part outputs at least part of the product transport control information searched according to the search requests. This arrangement enables the control and transport of the products more appropriately.

Here, the transport information may be information that includes the present positions of the transporting bodies and the information output part may be arranged to output the present position of the transporting bodies as part of the product transport control information, or the transport information may be information that includes the arrival schedules of the transporting bodies and the information output part may be arranged to output the arrival schedules of the transporting bodies as part of the product transport control information. Also, the transport information maybe information that includes the route points of the transporting bodies, and the information output part may be arranged to output the route points of the transporting bodies as part of the product transport control information. In this case, the transport information may be information that includes the arrival schedules of the transporting bodies at the route points, and the information output part may be arranged to output the arrival schedules of the transporting bodies at the route points as part of the product transport control information. By thus outputting the product transport control information upon inclusion of the present positions of the transporting bodies, the arrival schedules, the route points of the transporting bodies, and the arrival schedules for the route points, the condition of transport of the products can be made known.

Further, in the product transport control system of the invention, the information output part maybe arranged to output information using a schematic image or output information to terminals that are connected via a network.

Furthermore, in the product transport control system of the invention, the sales office computers installed at multiple sales offices may be arranged to be connected via the network. The sales office computers may include a search request transmitting part for transmitting the predetermined search requests to the product transport control computer, an information input part for inputting information transmitted form the product transport control computer according to the predetermined search requests, a receipt information generating part for generating receipt information necessary for inventory accounting from the input information, and an inventory accounting part for carrying out inventory accounting based on the generated receipt information. With this arrangement, automation of such product registration processes as receipt registration, inventory registration, etc. can be achieved. The sales office computers may include a search request transmitting part for transmitting the predetermined search requests to the product transport control computer, an information input part for inputting information transmitted form the product transport control computer according to the predetermined search requests, and an allocation part for performing allocation of products in the process of transport based on the input information. As a result, products can be delivered directly without having to carry the products once into a warehouse, etc.

### BRIEF DESCRIPTION OF THE DRAWINGS

FIG. 1 is a block diagram, which shows, in outline, the arrangement of a product transport control system, which is an embodiment of this invention,

FIG. 2 is a flowchart, which shows an example of a product shipment information processing routine, which is executed by computers of the respective production sites that comprise the product transport control system,

FIG. 3 is an explanatory diagram, which shows an example of an input column for product shipment information that are input by means of a computer at a production site,

FIG. 4 is a flowchart, which shows an example of a transport information processing routine, which is executed by computers of the respective transporting agencies that comprise the product transport control system,

FIG. 5 is an explanatory diagram, which shows an example of an input column for transport information that are input by means of a computer at a transporting agency,

FIG. 6 is a flowchart, which shows an example of a product transport control process routine that is executed by a computer for product transport control that comprises the product transport control system,

FIG. 7 is an explanatory diagram, which shows an example of product transport control information,

FIG. 8 is a flowchart, which shows an example of a product transport information display process routine that is executed by the computer for product transport control or a computer at a production site, transporting agency, or sales office that comprises the product transport control system,

FIG. 9 is an explanatory diagram, which shows an example of a screen that displays the present position of a transporting body,

FIG. 10 is an explanatory diagram, which shows an example of information that is displayed at a sales office,

FIG. 11 is a flowchart, which shows an example of an inventory registration process routine that is executed by computers at the respective sales offices,

FIG. 12 is a flowchart, which shows an example of an allocation process routine that is executed by the computer for product transport control or by a computer at a sales office,

FIG. 13 is a flowchart, which shows an example of a search process routine that is executed by the computer at sales office 1 and the computer for product transport control,

FIG. 14 is an explanatory diagram, which shows an example of a search dialog that is displayed on the monitor of the computer at sales office 1, and

FIG. 15 is an explanatory diagram, which shows an example of a list of search results.

### DETAILED DESCRIPTION OF THE PREFERRED EMBODIMENTS

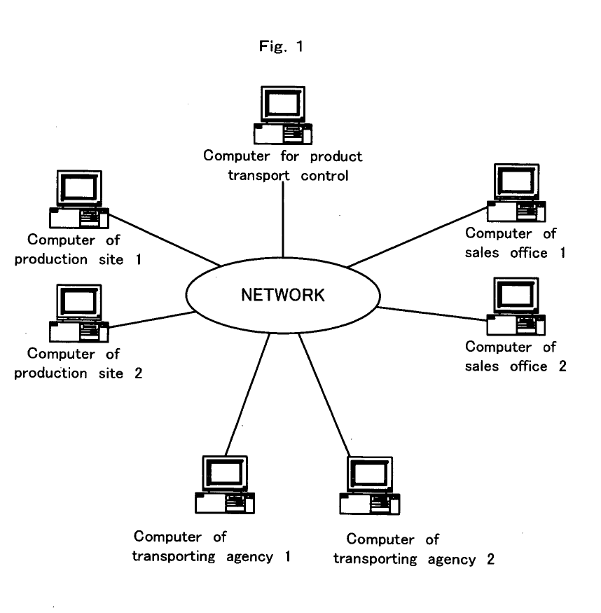

Preferred embodiments of this invention shall now be described. FIG. 1 is a block diagram, which shows, in outline, the arrangement of a product transport control system, which is an embodiment of this invention. As is illustrated, the product transport control system of this embodiment is formed as a network arranged from a computer for product transport control, which is installed at a product transport control center, etc., computers, which are installed as terminals at the respective production sites, such as production site 1, production site 2, etc., computers, which are installed as terminals at the respective transporting agencies, such as transporting agency 1, transporting agency 2, etc., and computers, which are installed at the respective sales offices, such as sales office 1, sales office 2, etc. or at warehouses, etc. In the following, an example where products produced at production sites are transported by vessels shall be described for this embodiment.

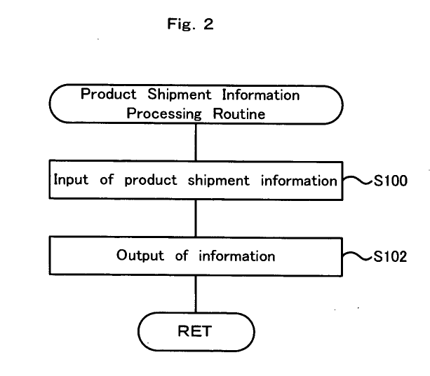

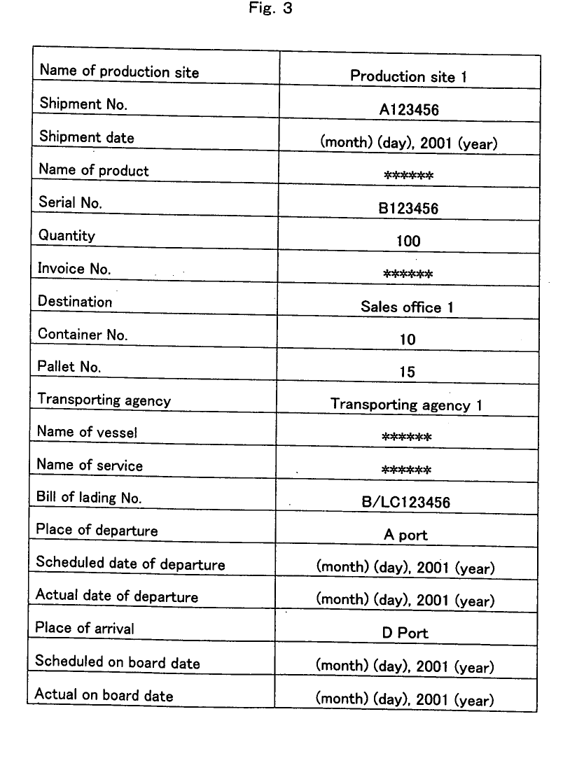

At a computer at each production site that comprises the product transport control system, a product shipment information processing routine, an example of which is illustrated in FIG. 2, is executed and the process of inputting product information and shipment information are carried out. This routine is executed when a predetermined operation, for example, the input of a product shipment information control command, is carried out in the process of shipping a product produced at a production site. When the production shipment information processing routine is executed, the computer at the production site first executes a process of receiving the input of product shipment information (step S100). To be more specific, a data input column, an example of which is shown in FIG. 3, is displayed and the input from a keyboard is waited for in this process. Example of the data that are input include such product information as the name of the production site, shipment number, shipment date, product name, serial number, quantity of product, invoice number, etc. and such shipment information as the destination, container number, pallet number, transporting agency, name of vessel, name of service, bill of lading number, place of departure, scheduled date of departure from place of departure, actual date of departure from place of departure, place of arrival, scheduled on board date, actual on board date, etc. Such product shipment information may be input according to each single product or may be input according to pallet or input according to container. That is, the information may be input collectively for a set of products of the same product name and continuous serial numbers.

When product shipment information have thus been input, the input product shipment information are output (step S102) and this routine is ended. For output of the product shipment information, for example, the product shipment information may be written into a predetermined folder prepared in the production site's computer's hard disk that can be accessed via the network by the computer for product transport control or the product shipment information may be output directly via the network to the computer for product transport control.

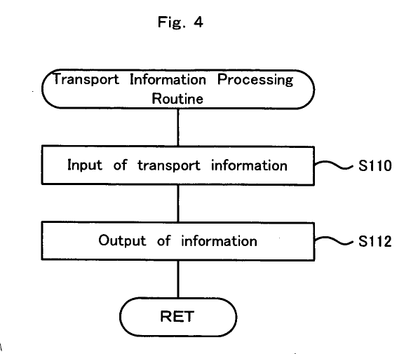

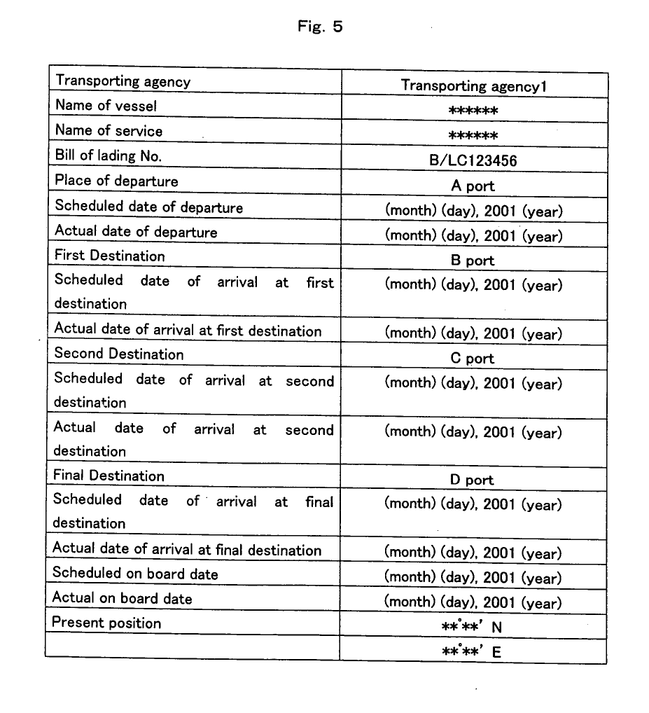

FIG. 4 is a flowchart, which shows an example of a transport information processing routine, which is executed by computers at the respective transporting agencies that comprise the product transport control system. This routine is executed when a transporting agency, such as transporting firm that performs transport activities using vessels, performs a predetermined operation, for example, the input of a command for transport information control, in a periodic or non-periodic manner. When the transport information processing routine is executed, a computer at the transporting agency first executes the process of inputting the conditions of transport by a vessel controlled by the transporting agency as the transport information (step S110). To be more specific, a data input column, an example of which is shown in FIG. 5, is displayed and the input from a keyboard is waited for in this process. Example of the data that are input include the transporting agency, name of vessel, name of service, bill of lading number, place of departure, schedule date of departure from place of departure, actual date of departure from place of departure, destination, scheduled date of arrival at destination, actual date of arrival at destination, final destination, scheduled date of arrival at final destination, actual date of arrival at final destination, scheduled on board date, actual on board date, present position, etc. For such transport information, though an arrangement wherein all of the data are input each time may be used, with the present embodiment, renewal of a part of the data that were input previously and addition of data are enabled.

When transport information have thus been input, the input transport information are output (step S112) and this routine is ended. For the output of the transport information, the transport information may be written into a predetermined folder prepared in the transporting agency's computer's hard disk that can be accessed via the network by the computer for product transport control or the transport information may be output directly via the network to the computer for product transport control.

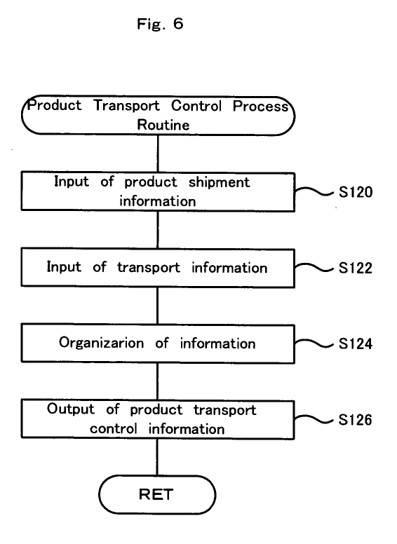

FIG. 6 is a flowchart, which shows an example of a product transport control process routine that is executed by the computer for product transport control that comprises the product transport control system. This routine is executed each time an employee of the product transport control center performs a predetermined operation, for example, the input of a command for product transport control or each time a predetermined amount of time elapses or each time the output of product shipment information or transport information from a computer at a production site or a computer at a transporting agency is detected. When the product transport control routine is executed, the computer for product transport control first executes a process of inputting the product shipment information that have been output from the computers of the respective production sites and the transport information that have been output from the computers of the respective transporting agencies (steps S120 and S122).

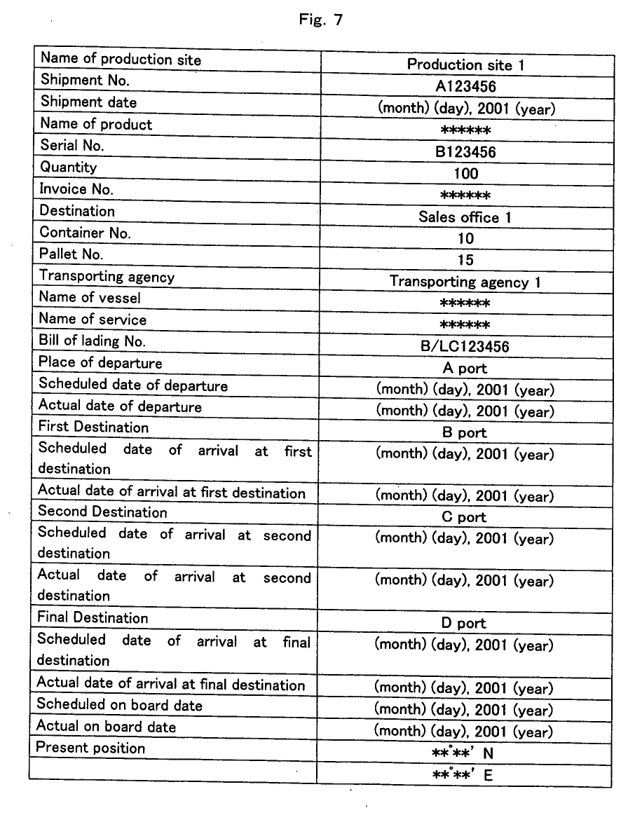

When the product shipment information and transport information have been input, a process of organizing the input information is carried out (step S124). To be more specific, in this process, unification and organization of data are carried out using the transporting agency, name of vessel, name of service, bill of lading number, etc. as keys, and the organized information are stored as product transport control information, an example of which is shown in FIG. 7, in a recording medium, such as the hard disk of the computer for product transport control. Since this routine is executed repeatedly and the product shipment information and transport information are renewed with the elapse of time as has been mentioned above, the product transport control information will also be renewed. That is, each time this routine is executed, a part or all of the product transport control information that are stored in the hard disk, etc. are renewed.

When product transport control information have thus been stored, the stored product transport control information are output (step S126) and this routine is ended. For the output of the product transport control information, the product transport control information may be written into a predetermined folder prepared in the hard disk of the computer for product transport control so as to enable access via the network by the computers of the respective production sites, respective transporting agencies, and respective sales offices or the product transport control information may be output directly via the network to the computers of the respective production sites, respective transporting agencies, and respective sales offices.

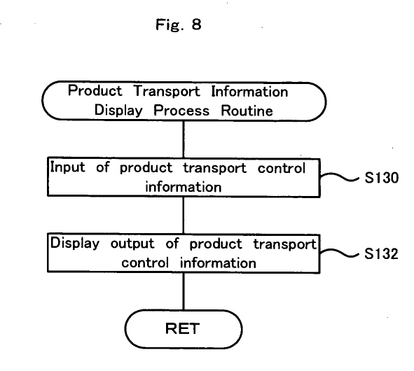

FIG. 8 is a flowchart, which shows an example of a product transport information display process routine that is executed by the computer for product transport control or the computers at respective production sites, respective transporting agencies, or respective sales offices that comprise the product transport control system. This routine is executed when a predetermined operation, for example, the input of a command for product transport information display, has been carried out at any of the above mentioned computers. When the product transport information display process routine is executed, the corresponding computer first executes the process of inputting the product transport control information (step S130). To be more specific, this process may be a process wherein a signal that requests the output of product transport control information is output via the network to the computer for product transport control and the product transport control information that are output in a predetermined format in response to this signal are read in, or a process wherein the product transport control information are input by directly accessing a predetermined folder prepared in the hard disk of the computer for product transport control that stores the product transport control information, or a process wherein the product transport control information, which have been input and stored via a network in the hard disks or the storage devices of the respective computers, are read.

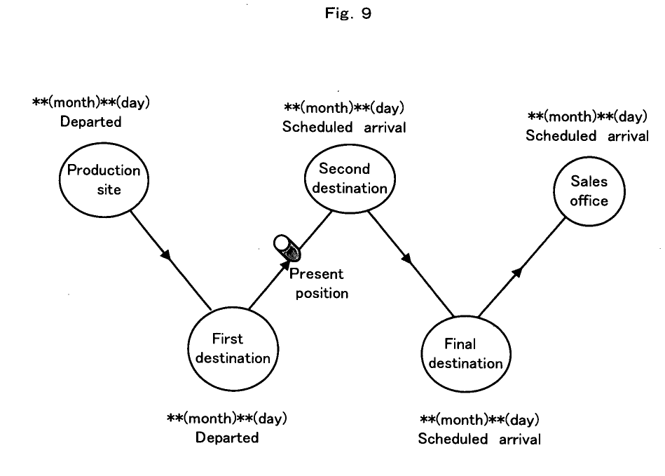

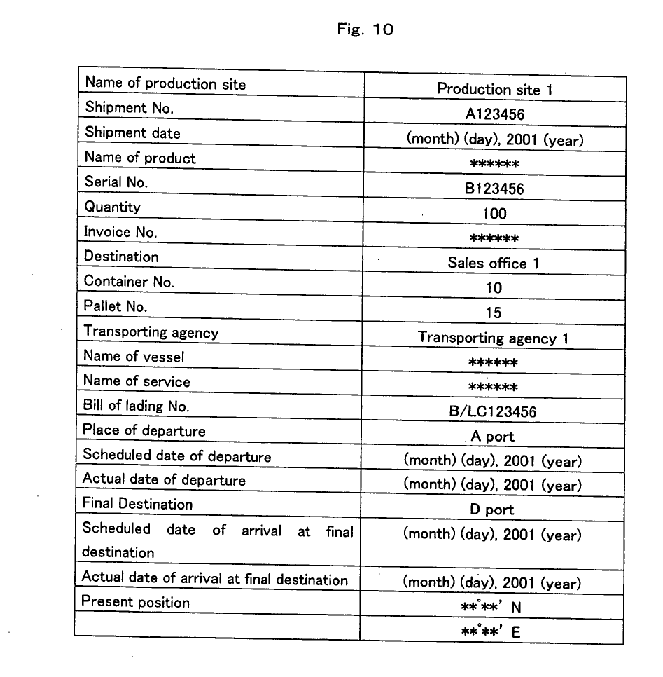

A display indicating at least part of the product transport control information and the present position of the transporting body (for example, a vessel) is output onto a monitor of the computer (step S132) and this routine is ended. Here, the display of the present position of the transporting body is for example performed by display of a screen, an example of which is shown in FIG. 9, on a monitor. The information that are displayed will differ according to whether the location of installation of the computer that has performed this display process is the product transport control center, a production site, a transporting agency, or a sales office. For example, at the product transport control center, all information are displayed as there is a need to control all of the information, at a production site, a part of the transport information is displayed in addition to the product information and the shipment information, at a transporting agency, a part of the shipment information is displayed in addition to the transport information, and at a sales office, a part of the shipment information and a part of the transport information are displayed in addition to the product information. An example of the information displayed at a sales office is shown in FIG. 10.

With the product transport control system of the embodiment described above, since the product information and shipment information, which have been input at production sites, and the transport information, which have been input at transporting agencies, are organized and renewed and made displayable at a computer at a sales office, etc., the control of products and the control of the transport of products can be unified. As a result, the products and the transport of products can be controlled more appropriately. Also, since the present position of the transporting body is displayed on a screen in a graphical manner, the present position of the transporting body can be made known and when the product will arrive can be made known at once. As a result of the above, a more appropriate sales schedule that incorporates the delivery schedule of products can be prepared at a sales office.

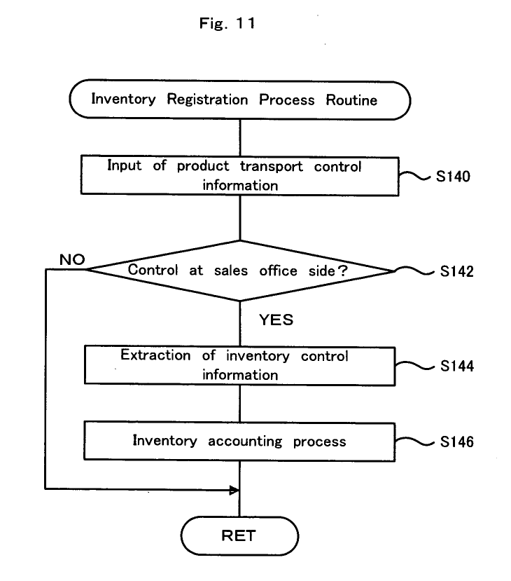

In the case where inventory control of each sales office is carried out by computers of the respective sales offices that comprise the product transport control system of the embodiment, the input of data for inventory control, such as inventory registration of products, can be automated. This automatic data input process shall now be described. FIG. 11 is a flowchart, which shows an example of an inventory registration process routine that is executed by the computers at the respective sales offices. This routine is executed when a predetermined operation, such as the input of a command for inventory registration, is carried out.

When the inventory registration process routine is executed, a computer at a sales office first executes a process of inputting product transport control information (step S140). This process of inputting product transport control information has been described above. Next, it is judged, based on the input product transport control information, whether or not the control of products has been transferred to the sales office side (step S142). For example in the case where the ownership of a product is transferred to the sales office side when the product is placed onboard the vessel of the transporting agency, the above mentioned judgment is made according to whether or not the actual on board date has been input, and in the case where the ownership of the product is transferred to the sales office side when the product has arrived at a destination near the sales office, the above mentioned judgment is made according to whether or not the actual date of arrival at the destination has been input. Though judgments based on the transfer of ownership of the product have been given as examples above, the judgment does not have to be made based on the ownership of a product and it is sufficient that the judgment be made according to where the boundary of control of the product lies.

If it has been judged that the control of the product lies in the sales office side, inventory control information, comprised of data necessary for inventory control, are extracted from the product transport control information (step S144), an inventory accounting process is carried out using the inventory control information (step S146), and this routine is ended. Here the inventory control information include the product name, serial number, quantity of product, invoice number, name of production site, etc.

By thus performing automatic input of the product inventory registration data and other data for inventory control, inventory control can be performed more appropriately. Also, more appropriate sales schedules can be prepared based on such appropriate inventory control.

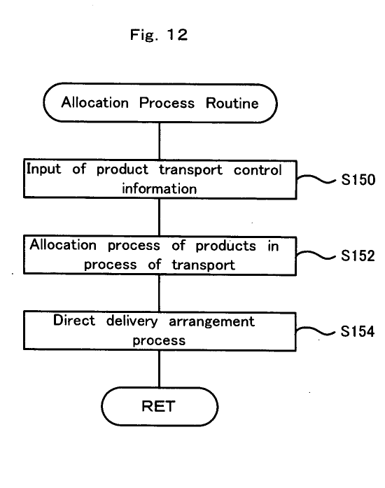

With the product transport control system of the embodiment, as a result of it being possible to carry out the control of products and transport appropriately, an allocation process can be carried out on products in the process of transport and the products can be delivered directly to customers. FIG. 12 is a flowchart, which shows an example of an allocation process routine that is executed by the computer for product transport control or by a computer at a sales office. This routine is executed when a predetermined operation, such as the input of a command for allocation process, is carried out.

When the allocation process routine is executed, a computer at a sales office or the computer for product transport control first inputs the product transport control information (step S150) and then uses the product transport control information to perform the allocation process on each product or a set of products arranged as a single group that is in the process of transport by inputting the addresses, etc. of the sales destinations (customers) or delivery destinations (step S152). Arrangements are then made for the delivery of the products, which have been subject to the allocation process, from the destinations for which the products are scheduled to arrive to the sales destinations (customers) (step S154), and this routine is ended.

Since allocation of products that are in the process of transport can be performed by performing the allocation process described above, the transport and delivery times can be shortened and the transport and delivery costs can be reduced in comparison to cases where the products are carried once into a warehouse and allocated thereafter.

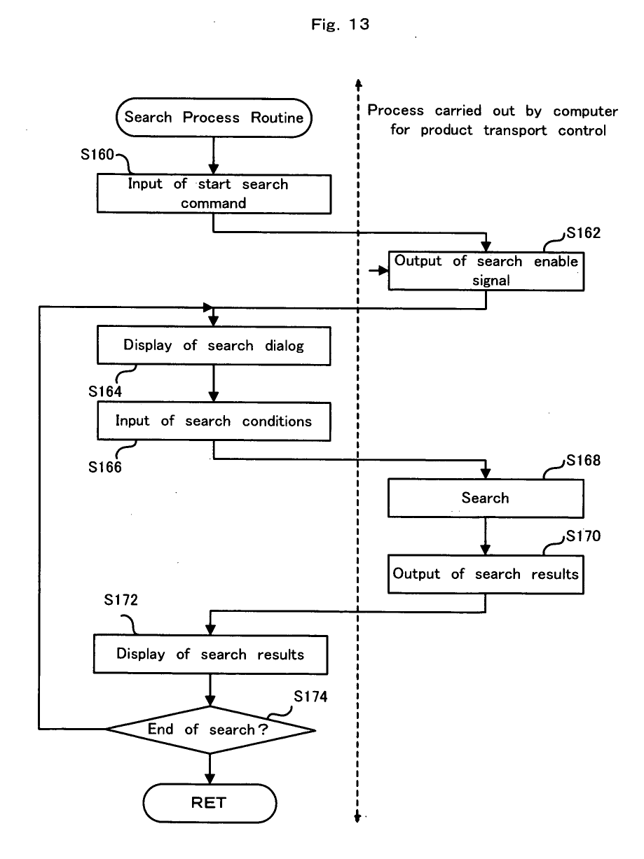

With the product transport control system of the embodiment, the product transport control information may be arranged and stored in the form of a database, product transport control information that correspond to search conditions input via the network may be searched based on the search conditions, and the results of the search may be displayed in a list. As an example of a search process performed on the prepared data, the case where a search process is performed using the computer of sales office 1 as a terminal shall now be described. FIG. 13 is a flowchart, which shows an example of a search process routine that is executed by the computer at sales office 1 and the computer for product transport control. The process at the left side of the broken line in the Figure is executed by the computer of sales office 1 and the process at the right side of the broken line in the Figure is executed by the computer for product transport control.

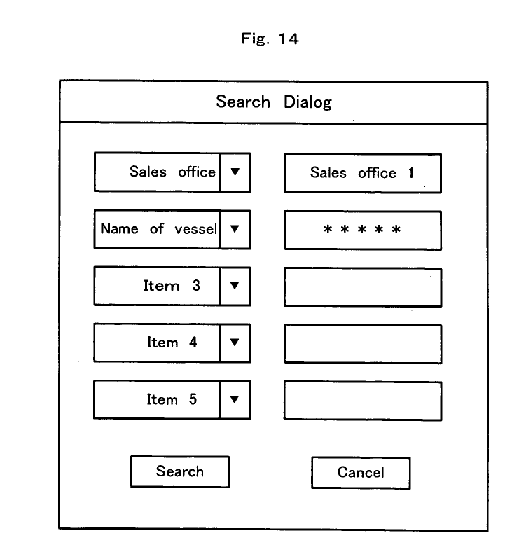

The search process routine starts with the process of inputting a start search command from the computer of sales office 1 (step S160). When this start search command is input, the computer of sales office 1 outputs a signal for enabling the search to the computer for product transport control via the network. In response to this signal, the computer for product transport control outputs a search enable signal to the computer of sales office 1 via the network (step S162). Upon input of this search enable signal, the computer of sales office 1 displays a search dialog on the monitor (step S164) and waits for the input of search conditions. An example of a search dialog is shown in FIG. 14. With the search dialog of this example, items are input selectively using the pull-down menus for five items that are aligned vertically at the left side and keywords are input as search conditions in the input boxes that are aligned vertically at the right side. The search is performed with the respective items that have been input being combined by the AND condition. When the search conditions have been input and the search button is pressed (step S166), the input search conditions and search command are output to the computer for product transport control via the network.

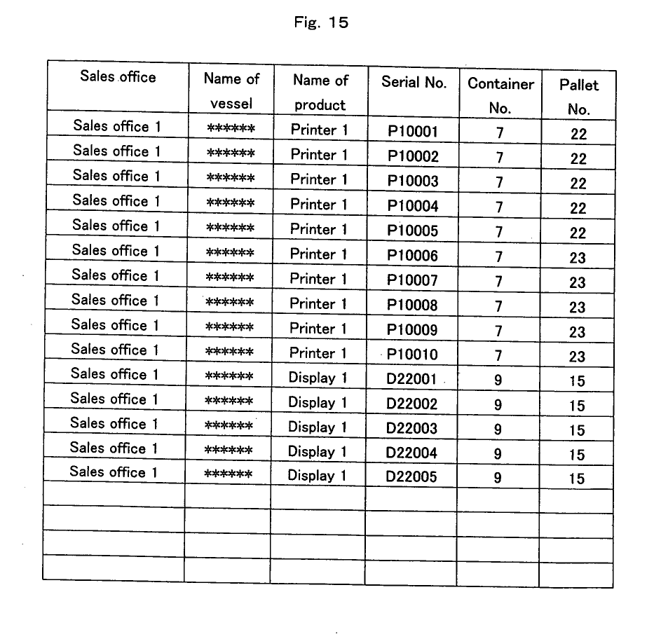

Upon input of the search conditions and the search command, the computer for product transport control extracts data that match the search conditions from the product transport control information that are arranged and stored in the form of a database in a hard disk or other storage device (step S168) and outputs the results to the computer of sales office 1 (step S170). These search results are displayed in a list on the monitor of the computer of sales office 1 (step S172). An example of a list of search results is shown in FIG. 15.

Judgment of the end of search is then made based on operations by the operator of the computer of sales office 1 (step S174). That is, if the operator performs the operation for carrying out a new search, a return to the search dialog display process of step S164 is performed while if the operator performs the operation for ending the search, the present routine is ended.

With the search process described above, product transport control information, which have been arranged and stored in the form of a database, can be searched based on search conditions that have been input via the network and the results of the search can be displayed in a list. As a result, appropriate information necessary for sales scheduling, inventory control, etc. can be searched and output. Also, when a problem occurs with a product, the cause of occurrence of the problem can be used to aid the investigation of production, transport, etc.

Though with this search process, a search was performed from the computer of sales office 1, a search can be performed from a computer of another sales office, the computer for product transport control or any of the computers of the respective production sites and computers of the respective transporting agencies. Also, whereas in the case where a search is performed from a computer of another sales office or a production site or a transporting agency, the same process as the process of the embodiment is performed, in the case where a search is performed from the computer for product transport control, the process can be one that is carried out by a single computer without inputs and outputs via the network.

Though with the product transport control system of the embodiment, the product information and shipment information were arranged to be input from computers installed as terminals at the respective production sites, such as production site 1, production site 2, etc., data on paper that have been provided from the respective production sites by fax, etc. maybe arranged to be input from the computer for product transport control that is installed at the product transport control center. Also, though with the product transport control system of the embodiment, the transport information were arranged to be input from computers installed as terminals at the respective transporting agencies, such as transporting agency 1, transporting agency 2, etc., data on paper that have been provided from the respective transporting agencies by fax, etc. may be arranged to be input from the computer for product transport control that is installed at the product transport control center. Furthermore, though with the product transport control system of the embodiment, computers installed as terminals at the respective sales offices, such as sales office 1, sales office 2, etc. were arranged to be connected via a network to the computer for product transport control, the computers do not have to be installed at the respective sales offices. In consideration of such modifications, the product transport control system may be established, as a minimum arrangement, with just the computer for product transport control.

Though with the product transport control system of the embodiment, a vessel was used as the transporting body and the control of products transported by the vessel and control of transport of the products were carried out, the transporting body is not limited to vessels and vehicles, such as automobiles, trains, etc., and aircraft may be used instead.

Though the embodiment described was that of a product transport control system by this invention, an embodiment may also be arranged in the form of a method for product transport control or an embodiment may be arranged in the form of a storage medium that stores a program that makes a computer function as a product transport control system of the embodiment described above or a modification thereof. In this case, the respective processes of the product transport control system described above can be indicated in a step by step manner using a suitable programming language and written in a recording medium. The recording medium may be any of various types, such as flexible disk, CD-ROM, DVD-ROM, etc.

Though an embodiment was used to describe a form of putting this invention into practice in the above, this invention is by no means limited to such an embodiment and needless to say, this invention can be put into practice in various forms within a range that does not fall outside the scope of the invention.

What is claimed is:

1. A product transport control system comprising production site computers installed at multiple production sites, transporting agency computers installed at multiple transporting agencies, and a product transport control computer for controlling products produced at the production sites and controlling a transport of the products, which are connected via a network,
each of said production site computers comprising; an information input part for inputting product information concerning the products produced at the production sites and shipment information concerning the shipment of the products, and an information transmitting part for transmitting the product information and the shipment information to said product transport control computer via said network,
each of said transporting agency computers comprising; an information input part for inputting transport information concerning transport by means of transporting bodies, and an information transmitting part for transmitting the transport information to said product transport control computer via said network, and
said product transport control computer comprising; a product shipment information receiving part for receiving the product information and the shipment information transmitted from said production site computers, a transport information receiving part for receiving the transport information transmitted from said transporting agency computers, an information storage part for integrating and organizing the product information and the shipment information received by said product shipment information receiving part and the transport information received by said transport information receiving part to store as product transport control information, a search request receiving part for receiving predetermined search requests via said network, a searching part that, when said search request receiving part received the predetermined search requests, searches the product transport control information stored in said information storage part based on the predetermined search requests, and an information output part for outputting at least part of the product transport control information searched by said searching part to a requester of the predetermined search requests.

2. A product transport control system in accordance with claim 1, wherein
the transport information includes present positions of the transporting bodies; and
said information output part is arranged to output the present positions of the transporting bodies as part of the product transport control information.

3. A product transport control system in accordance with claim 1, wherein
the transport information includes arrival schedules of the transporting bodies; and
said information output part is arranged to output the arrival schedules of the transporting bodies as part of the product transport control information.

4. A product transport control system in accordance with claim 1, wherein
the transport information includes route points of the transporting bodies; and
said information output part is arranged to output the route points of the transporting bodies as part of the product transport control information.

5. A product transport control system in accordance with claim 4, wherein
the transport information includes arrival schedules of the transporting bodies at the route points; and
said information output part is arranged to output the arrival schedules of the transporting bodies at the route points as part of the product transport control information.

6. A product transport control system in accordance with claim 1, wherein
the product information includes product names and product numbers of the products; and
said information output part is arranged to output the product names or product numbers of the products as part of the product transport control information.

7. A product transport control system in accordance with claim 1, wherein
the shipment information includes names of transporting bodies, units of transport, and dates of start of transport; and
said information output part is arranged to output at least a part of the names of transporting bodies, the units of transport, and the dates of start of transport as part of the product transport control information.

8. A product transport control system in accordance with claim 7, wherein
the units of transport are containers, pallets, or other units used in loading onto the transporting bodies.

9. A product transport control system in accordance with claim 1, wherein
the transporting bodies are one of vessels, aircrafts, and vehicles.

10. A product transport control system in accordance with claim 1, wherein
said information output part outputs information using a schematic image.

11. A product transport control system in accordance with claim 1, wherein
sales office computers installed at multiple sales offices are arranged to be connected via said network.

12. A product transport control system in accordance with claim 11, wherein
said sales office computers comprising a search request transmitting part for transmitting the predetermined search requests to said product transport control computer, an information input part for inputting information transmitted form said product transport control computer according to the predetermined search requests, a receipt information generating part for generating receipt information necessary for inventory accounting from the input information, and an inventory accounting part for carrying out inventory accounting based on the generated receipt information.

13. A product transport control system in accordance with claim 11, wherein
said sales office computers comprising a search request transmitting part for transmitting the predetermined search requests to said product transport control computer, an information input part for inputting information transmitted form said product transport control computer according to the predetermined search requests, and an allocation part for performing allocation of products in the process of transport based on the input information.
